(19) United States
(12) Patent Application Publication
(10) Pub. No.: US 2012/0306265 A1
(43) Pub. Date: Dec. 6, 2012

(54) POWER FEEDING DEVICE AND VEHICLE POWER FEEDING SYSTEM

(75) Inventors: Yukihiro Yamamoto, Kariya-shi (JP); Tsuyoshi Koike, Kariya-shi (JP)

(73) Assignees: KABUSHIKI KAISHA TOYOTA JIDOSHOKKI, Kariya-shi, Aichi-ken (JP); TOYOTA JIDOSHA KABUSHIKI KAISHA, Toyota-shi, Aichi-ken (JP)

(21) Appl. No.: 13/578,517

(22) PCT Filed: Feb. 9, 2011
(86) PCT No.: PCT/IB11/00216

§ 371 Date: Aug. 10, 2012

(30) Foreign Application Priority Data
Feb. 12, 2010 (JP) 2010-028819

(51) Int. Cl. H02J 17/00; B60L 1/00

(52) U.S. Cl. 307/9.1; 307/104

(57) ABSTRACT

A power feeding device includes a network analyzer that measures measurement of S-parameters of a resonant system that includes an electromagnetic induction coil and a resonance coil, and an electronic control unit (ECU). The ECU adjusts the resonant frequency of the resonance coils to the power supply frequency in accordance with the measured S-parameters. Specifically, the ECU controls variable capacitors to adjust the resonant frequency of resonance coils and, after adjusting the resonant frequency, controls an impedance matching device to match the input impedance of the resonant system with the impedance on a high-frequency power supply device side viewed from the input port of the resonant system.

### BACKGROUND OF THE INVENTION

1. Field of the Invention

The present invention relates to a power feeding device and a vehicle power feeding system that has a power transmission coil that resonates with a power receiving coil of a power receiving device via an electromagnetic field to feed electric power to the power receiving device in a non-contact manner.

2. Description of the Related Art

Electric vehicles such as electric-powered cars and hybrid cars are receiving much attention as environmentally-friendly vehicles. These vehicles are equipped with an electric motor that propels the vehicle and a rechargeable electric storage device that stores the electric power supplied to the electric motor. The term “hybrid cars” refer to cars that are equipped with an internal combustion engine and an electric motor as power sources as well as cars that are equipped with a fuel cell as a DC power supply to propel the vehicle in addition to an electric storage device.

Hybrid cars are known to include on-board electric storage devices that can be charged, as in the case with electric vehicles, from an external power supply. For example, “plug-in hybrid cars,” as they called, include electric storage devices that may be charged from standard home power supplies by connecting a household power outlet and a charging port of the vehicle with a charging cable.

In contrast, wireless power transmission that uses no power supply cord or power transmission cable is attracting attention as a power transmission method. As dominant wireless power transmission methods, three techniques are known: power transmission using electromagnetic induction, power transmission using microwaves, and power transmission by a resonance method.

Among the wireless power transmission methods, the resonance method is a non-contact power transmission technique in which a pair of resonators (for example, a pair of resonance coils) are resonated in an electromagnetic field (near-field) to transmit electric power via the electromagnetic field, and can transmit a high power of several kW over a relatively long distance (several meters, for example).

A vehicle power feeding system that wirelessly feeds electric power from an external power feeding device to an electric vehicle using the resonance method is described in, for example, Japanese Patent Application Publication No. 2009-106136 (JP-A-2009-106136).

If the positional relation between the power transmission coil of the power feeding device and the power receiving coil on the power receiving side (vehicle) changes, the efficiency of power transmission from the power transmission coil to the power receiving coil changes and the efficiency of feeding power from the power feeding device to the power receiving device changes. Thus, maintaining efficient power feed despite changes in positional relation between the power transmission coil and the power receiving coil remains a technical challenge. Also, the adjustment method for achieving highly efficient power feeding is preferably as simple as possible.

### SUMMARY OF THE INVENTION

The present invention provides a power feeding device and a vehicle power feeding system that can achieve highly effective power feeding by simple adjustments.

A power feeding device according to a first aspect of the present invention is a power feeding device that feeds electric power to a power receiving device that includes a power receiving coil in a non-contact manner, and includes a power supply device, a power transmission coil, first and second adjusting devices, a detection device, and a control device. The power supply device generates electric power with a prescribed frequency. The power transmission coil receives the electric power generated by the power supply device and transmits the electric power to the power receiving coil in a non-contact manner by resonating with the power receiving coil via an electromagnetic field. The first adjusting device adjusts the resonant frequency of the power transmission coil. The second adjusting device adjusts the input impedance of a resonant system that includes the power transmission coil and the power receiving coil. The detection device detects at least one of a transmission characteristic and a reflection characteristic of the resonant system. The control device, based on a result of detection by the detection device, adjusts the resonant frequency to the prescribed frequency by controlling the first adjusting device and matches the input impedance of the resonant system with the impedance on the power supply device side viewed from the input port of the resonant system by controlling the second adjusting device.

The control device may first adjust the resonant frequency to the prescribed frequency by controlling the first adjusting device, and, after the adjustment of the resonant frequency, perform the impedance matching by controlling the second adjusting device.

The control device may determine whether or not the distance between the power transmission coil and the power receiving coil is smaller than a prescribed reference value, and adjust the resonant frequency by controlling the first adjusting device if it is determined that the distance between the coils is smaller than the reference value and adjust the input impedance of the resonant system by controlling the second adjusting device if it is determined that the distance between the coils is equal to or greater than the reference value.

The first adjusting device may include a variable capacitor that is provided in the power transmission coil. The second adjusting device may include an LC circuit that is provided between the power transmission coil and the power supply device. The LC circuit may include at least one of a variable capacitor and a variable coil.

The power transmission coil may include a resonance coil, and an electromagnetic induction coil that is connected to the power supply device and supplies the electric power that is received from the power supply device to the resonance coil by electromagnetic induction, and the second adjusting device may adjust the input impedance of the resonant system by changing the distance between the resonance coil and the electromagnetic induction coil.

A vehicle power feeding system according to a second aspect of the present invention includes a power feeding device, and a vehicle that is supplied with electric power from the power feeding device. The power feeding device includes a power supply device, a power transmission coil, and a first adjusting device. The power supply device generates electric power with a prescribed frequency. The power transmission coil receives the electric power that is generated by the power supply device and generates an electromagnetic field that is used to transmit the electric power to the vehicle in a non-contact manner. The first adjusting device adjusts the resonant frequency of the power transmission coil. The vehicle includes a power receiving coil, and a second adjusting device. The power receiving coil receives electric power from the power transmission coil in a non-contact manner by resonating with the power transmission coil of the power feeding device via the electromagnetic field. The second adjusting device adjusts the resonant frequency of the power receiving coil. The power feeding device further includes a third adjusting device, a detection device, and a control device. The third adjusting device adjusts the input impedance of a resonant system that includes the power transmission coil and the power receiving coil. The detection device detects at least one of a transmission characteristic and a reflection characteristic of the resonant system. The control device, based on a result of detection by the detection device, adjusts the resonant frequency of the power transmission coil and the power receiving coil to the prescribed frequency by controlling the first and second adjusting devices and matches the input impedance of the resonant system with the impedance on the power supply device side viewed from the input port of the resonant system by controlling the third adjusting device.

The control device may first adjust the resonant frequency to the prescribed frequency by controlling the first and second adjusting devices, and, after the adjustment of the resonant frequency, perform the impedance matching by controlling the third adjusting device.

The control device may determine whether or not the distance between the power transmission coil and the power receiving coil is smaller than a prescribed reference value, and adjust the resonant frequency by controlling the first and second adjusting device if it is determined that the distance between the coils is smaller than the reference value and adjust the input impedance by controlling the third adjusting device if it is determined that the distance between the coils is equal to or greater than the reference value.

In this present invention, based on the result of detection by the detection device, the resonant frequency of the coil is adjusted to the prescribed frequency by controlling the first adjusting device and the input impedance of the resonant system is matched with the impedance on the power supply device side viewed from the input port of the resonant system by controlling the second adjusting device. Therefore, the adjustment of the resonant frequency and the impedance matching can be adjusted separately. Therefore, according to the present invention, highly efficient power feeding can be achieved by simple adjustments.

### BRIEF DESCRIPTION OF THE DRAWINGS

The foregoing and further features and advantages of the invention will become apparent from the following description of example embodiments with reference to the accompanying drawings, wherein like numerals are used to represent like elements, and wherein:

FIG. 1 is a functional block diagram that illustrates the overall configuration of a vehicle power feeding system according to a first embodiment of the present invention;

FIG. 2 is a circuit diagram of an equivalent circuit of the part that executes power transmission in a resonance method;

FIG. 3 is a view that illustrates an example of circuit configuration of an impedance matching device that is shown in FIG. 1;

FIG. 4 is a first chart that shows the transmission characteristic (S21) and reflection characteristic (S11) of a resonant system;

FIG. 5 is a second chart that shows the transmission characteristic (S21) and reflection characteristic (S11) of a resonant system;

FIG. 6 is a third chart that shows the transmission characteristic (S21) and reflection characteristic (S11) of a resonant system;

FIG. 7 shows the changes in transmission characteristic (S21) that occur when the capacitance of the variable capacitors shown in FIG. 1 is varied;

FIG. 8 is a chart that shows the changes in reflection characteristic (S11) when the capacitance of the variable capacitors shown in FIG. 1 is varied;

FIG. 9 is a chart that shows the change in transmission characteristic (S21) when impedance matching is performed using the impedance matching device shown in FIG. 1;

FIG. 10 is a flowchart that shows the process executed in an ECU to adjust the resonant frequency of resonance coils and match the impedance of the resonant system;

FIG. 11 is a flowchart that shows the process executed in an ECU to adjust the resonant frequency of resonance coils and match the impedance of the resonant system in a second embodiment; and

FIG. 12 shows an alternative method of impedance matching.

### DETAILED DESCRIPTION OF EMBODIMENTS

Embodiments of the present invention are described below with reference to the drawings. In the drawings, the same or corresponding parts are indicated by the same reference numerals and description thereof is not repeated.

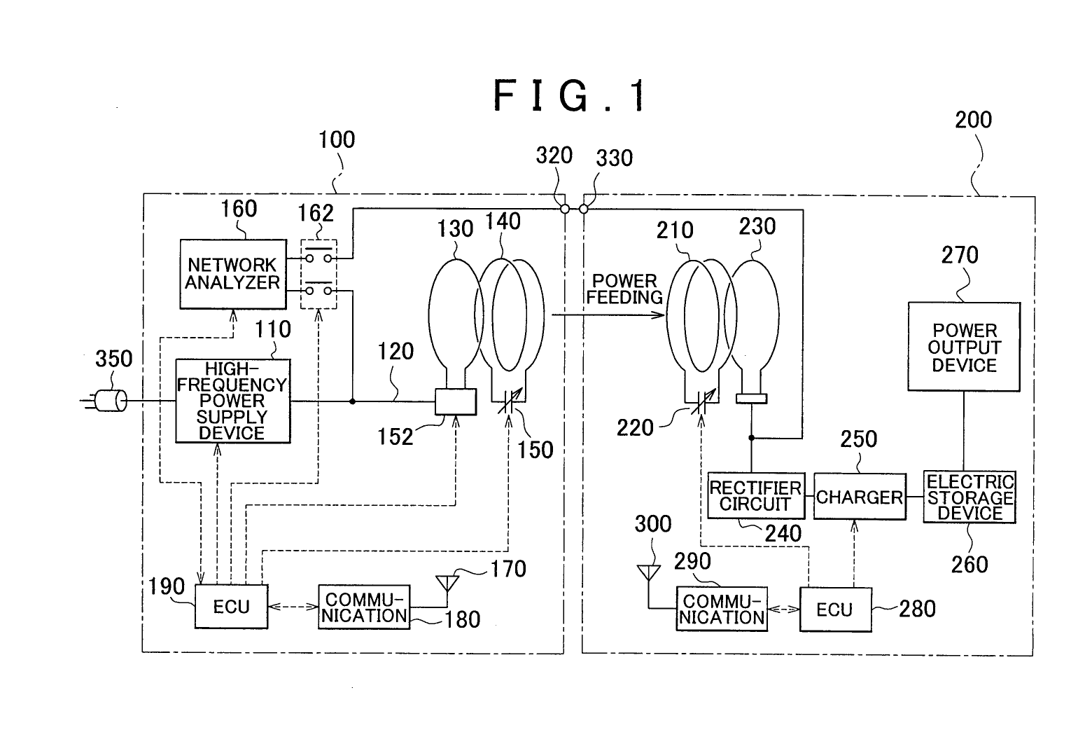

FIG. 1 is a functional block diagram that illustrates the overall configuration of a vehicle power feeding system according to a first embodiment of the present invention. Referring to FIG. 1, the vehicle power feeding system includes a power feeding device 100, and a vehicle 200.

The power feeding device 100 includes a high-frequency power supply device 110, a coaxial cable 120, an electromagnetic induction coil 130, and a resonance coil 140. The power feeding device 100 also includes a variable capacitor 150, an impedance matching device 152, a network analyzer 160, and a relay 162. In addition, the power feeding device 100 also includes a communication antenna 170, a communication device 180, and an electronic control unit (ECU) 190.

The high-frequency power supply device 110 converts system electric power that may be received through a power supply plug 350 that is connected to a system power supply, for example, into prescribed high-frequency electric power, and outputs the high-frequency electric power to the coaxial cable 120. The frequency of the high-frequency electric power generated by the high-frequency power supply device 110 is set to a prescribed value in the range of 1 MHz to a dozen MHz or so.

The electromagnetic induction coil 130 is disposed generally coaxially with the resonance coil 140, and is separated from the resonance coil 140 by a prescribed distance. The electromagnetic induction coil 130 may be magnetically coupled with the resonance coil 140 by electromagnetic induction, and supplies the high-frequency electric power that is supplied from the high-frequency power supply device 110 through the coaxial cable 120 to the resonance coil 140 by electromagnetic induction.

An impedance matching device 152 is provided on the input side of the electromagnetic induction coil 130. The impedance matching device 152 matches the input impedance of a resonant system that includes the electromagnetic induction coil 130 and the resonance coil 140 and a resonance coil 210 and an electromagnetic induction coil 230 (which are described later), which are mounted on the vehicle 200, with the impedance on the high-frequency power supply device 110 side viewed from the input port of the resonant system. The impedance matching device 152 adjusts the input impedance of the resonant system in accordance with commands from the ECU 190.

The resonance coil 140 is supplied with electric power from the electromagnetic induction coil 130 by electromagnetic induction. The resonance coil 140 transmits electric power to the vehicle 200 in a non-contact manner by resonating with the resonance coil 210 for power reception that is equipped in the vehicle 200 via an electromagnetic field. The diameter and number of turns of the resonance coil 140 are appropriately set based on the distance to the resonance coil 210 of the vehicle 200 and the resonance frequency so that a large Q-factor (for example, Q>100) and a large degree of coupling κ can be obtained.

The resonance coil 140 includes the variable capacitor 150, and the variable capacitor 150 is connected, for example, between opposite ends of the resonance coil 140. The variable capacitor 150 changes in capacitance in accordance with commands from the ECU 190, and adjusts the resonant frequency of the resonance coil 140 by the change in capacitance.

The network analyzer 160 detects S-parameters that indicate the transmission characteristic (S21) and reflection characteristic (S11) of the resonant system that includes the electromagnetic induction coil 130 and the resonance coil 140, and the resonance coil 210 and the electromagnetic induction coil 230 on the vehicle 200. The network analyzer 160 is connected to the resonant system by electrically connecting terminal 320 with terminal 330, and by turning on the relay 162. The network analyzer 160 measures the S-parameters (S11, S21) of the resonant system based on a command from the ECU 190 and outputs the measured S-parameters (S11, S21) to the ECU 190. A commercially available product may be used as the network analyzer 160.

The communication antenna 170 is connected to the communication device 180. The communication device 180 serves as a communication interface for communicating with a communication device 290 of the vehicle 200.

The ECU 190 adjusts the resonant frequency of the resonance coils 140 and 210 to the power supply frequency (the frequency of the high-frequency electric power that is output from the high-frequency power supply device 110) by controlling the variable capacitors 150 and 220 based on the S-parameters as measured by the network analyzer 160. The ECU 190 also matches the input impedance of the resonant system with the impedance on the high-frequency power supply device 110 side viewed from the input port of the resonant system by controlling the impedance matching device 152 based on the measured S-parameters.

More specifically, when the relay 162 is turned on to connect the network analyzer 160, the ECU 190 first adjusts the resonant frequency of the resonance coils 140 and 210 by controlling the variable capacitors 150 and 220 based on the S-parameters measured by the network analyzer 160. Then, after adjusting the resonant frequency, the ECU 190 matches the impedance by controlling the impedance matching device 152. To the variable capacitor 220 of the vehicle 200, a command for the adjustment is provided from an ECU 280 via the communication devices 180 and 290.

The adjustment of the resonant frequency of the resonance coils is preferably carried out with the mutual inductance between the resonance coils 140 and 210 being low, in other words, with sufficient distance between the resonance coils 140 and 210 being secured so that two peaks do not appear (that is, only one peak appears) in the frequency spectrum of the S-parameters, as described later. This is because the resonant frequency does not change even if the gap between the resonance coils 140 and 210 varies when mutual inductance is low, whereas the resonant frequency changes with variation of the gap between the resonance coils 140 and 210 when the mutual inductance is large. This point is described later with reference to drawings.

The vehicle 200 includes the resonance coil 210, the variable capacitor 220, the electromagnetic induction coil 230, a rectifier circuit 240, a charger 250, an electric storage device 260, a power output device 270, and a switch 275. The vehicle 200 also includes the ECU 280, the communication device 290, and a communication antenna 300.

The resonance coil 210 of the vehicle 200 receives electric power from the resonance coil 140 of the power feeding device 100 in a non-contact manner by resonating with the resonance coil 140 of the power feeding device 100 via an electromagnetic field. The diameter and number of turns of the resonance coil 210 are also appropriately set based on the distance from the resonance coil 140 of the power feeding device 100 and the resonance frequency so that a large Q-factor (for example, Q>100) and a large degree of coupling κ can be obtained.

The resonance coil 210 includes the variable capacitor 220, and the variable capacitor 220 is connected, for example, between opposite ends of the resonance coil 210. The variable capacitor 220 changes in capacitance in accordance with commands from the ECU 280, and adjusts the resonant frequency of the resonance coil 210 by the change in capacitance.

The electromagnetic induction coil 230 is disposed generally coaxially with the resonance coil 210 with a prescribed distance to the resonance coil 210. The electromagnetic induction coil 230 may be magnetically coupled with the resonance coil 210 by electromagnetic induction, and takes out the electric power that is received by the resonance coil 210 by electromagnetic induction and outputs the electric power to the rectifier circuit 240.

The rectifier circuit 240 rectifies the electric power (AC) that is taken out of the resonance coil 210 by the electromagnetic induction coil 230 and outputs the rectified electric power to the charger 250. The charger 250 converts the electric power that has been rectified by the rectifier circuit 240 to the voltage level of the electric storage device 260 in accordance with a control signal from the ECU 280 and outputs the converted electric power to the electric storage device 260.

The electric storage device 260 is a rechargeable DC power supply, and includes a secondary battery, such as a lithium ion or nickel-hydride battery. The electric storage device 260 not only stores the electric power that is supplied from the charger 250 but also stores the regenerated electric power generated by the power output device 270. The electric storage device 260 supplies the stored electric power to the power output device 270. A high-capacity capacitor may be employed as the electric storage device 260, and any electric power buffer that can temporarily store the electric power supplied from the power feeding device 100 and the regenerate electric power from the power output device 270 and supply the stored electric power to the power output device 270 may be used.

The power output device 270 propels the vehicle 200 using the electric power that is stored in the electric storage device 260. Although not shown specifically, the power output device 270 includes, for example, an inverter that receives the electric power output from the electric storage device 260, a motor that is driven by the inverter, driving wheels that receive drive force from the motor, and so on. The power output device 270 may include an engine that drives a power generator for charging the electric storage device 260.

The ECU 280 outputs a power transmission request command to the communication device 290 to have the power feeding device 100 transmit power to the vehicle 200. When the power feeding device 100 is feeding power to the vehicle 200, the ECU 280 controls the operation of the charger 250. Specifically, the ECU 280 controls the charger 250 so that electric power output from the rectifier circuit 240 is converted into the voltage level of the electric storage device 260. The communication device 290 is a communication interface for communicating with the communication device 180 of the power feeding device 100. The communication antenna 300 is connected to the communication device 290.

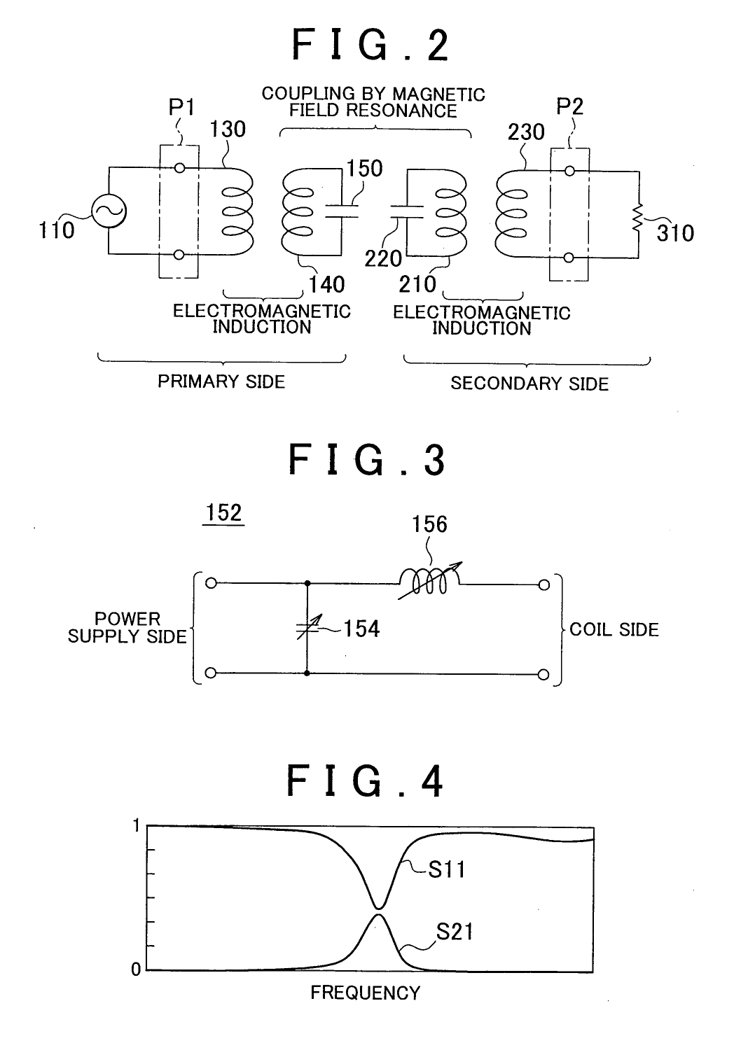

FIG. 2 is a circuit diagram of an equivalent circuit of the part that executes power transmission in a resonance method. Referring to FIG. 2, in the resonance method, by the resonance of the two resonance coils 140 and 210, similar to the resonance between two tuning forks, in an electromagnetic field (near-field), electric power is transmitted from the resonance coil 140 to the resonance coil 210 via the electromagnetic field.

Specifically, high-frequency electric power of a constant frequency, between several MHz and a dozen MHz or so, is supplied from the high-frequency power supply device 110 to the electromagnetic induction coil 130, and the electric power is then supplied to the resonance coil 140 that is magnetically coupled with the electromagnetic induction coil 130 by electromagnetic induction. The resonance coil 140 may be electrically resonated by its own inductance and the variable capacitor 150, and resonates with the resonance coil 210 on the vehicle 200 side via an electromagnetic field (near-field). Then, energy (electric power) is transferred from the resonance coil 140 to the resonance coil 210 via the electromagnetic field. The energy (electric power) that is transferred to the resonance coil 210 is taken out by the electromagnetic induction coil 230 that is magnetically coupled with the resonance coil 210 by electromagnetic induction, and is then supplied to a load 310 (which refers to the entire electric system downstream of the rectifier circuit 240 (FIG. 1)).

The transmission characteristic (S21) that is measured by the network analyzer 160 (FIG. 1) corresponds to the ratio at which the input electric power into the port P1 (the electric power that is output from the high-frequency power supply device 110) reaches the port P2 through the resonant system that is formed between the ports P1 and P2 (in reality, the impedance matching device 152 is provided on the input side of the electromagnetic induction coil 130), in other words, the transfer coefficient from the port P1 to the port P2. In addition, the reflection characteristic (S11) corresponds to the ratio of electric power that is reflected to the input electric power into the port P1, in the resonant system that is formed between the ports P1 and P2, in other words, the reflection coefficient at the port P1.

FIG. 3 illustrates an example of circuit configuration of the impedance matching device 152 that is shown in FIG. 1. Referring to FIG. 3, the impedance matching device 152 includes a variable capacitor 154 and a variable coil 156. The variable capacitor 154 is connected in parallel to the high-frequency power supply device 110 (not shown). The variable coil 156 is connected between the impedance matching device 152 and the electromagnetic induction coil 130 (not shown). The impedance of the impedance matching device 152 is changed by changing at least one of the capacitance of the variable capacitor 154 and the inductance of the variable coil 156. However, either of the variable capacitor 154 or the variable coil 156 may be invariable.

FIG. 4 to FIG. 6 show the transmission characteristic (S21) and reflection characteristic (S11) of the resonant system that includes the resonance coils 140 and 210 and the electromagnetic induction coils 130 and 230. FIG. 4 to FIG. 6 show the transmission characteristics (S21) and reflection characteristics (S11) for different gaps between the resonance coil 140 of the power feeding device 100 and the resonance coil 210 of the vehicle 200. FIG. 4 shows the transmission characteristics (S21) and reflection characteristics (S11) when the gap between the resonance coils 140 and 210 is the largest, and FIG. 6 shows the transmission characteristics (S21) and reflection characteristics (S11) when the gap between the resonance coils 140 and 210 is the smallest.

Referring to FIG. 4, each of the S-parameters (S11, S21) has a peak at a specific frequency (resonant frequency). In FIG. 4, the S-parameter (S11, S21) has only one peak because the gap between the resonance coils 140 and 210 is large.

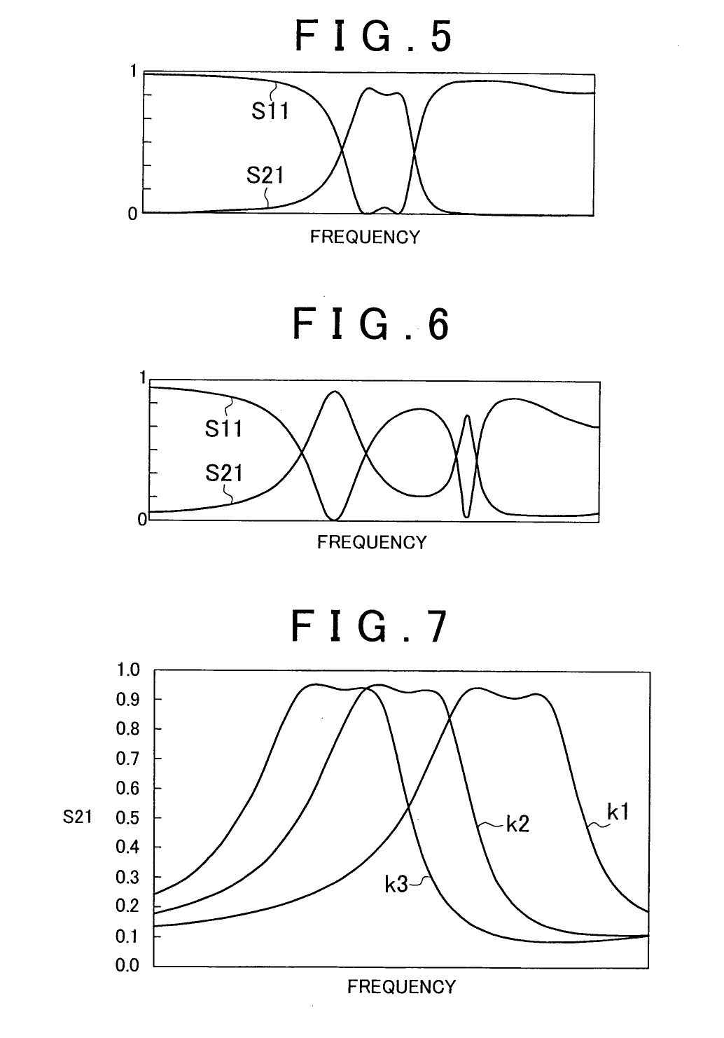

Referring to FIG. 5, if the gap between the resonance coils 140 and 210 is decreased, the peak values increase, whereas the peak frequency does not change. In FIG. 5, each peak starts to be divided into two due to the influence of mutual inductance between the resonance coils 140 and 210.

Referring to FIG. 6, when the gap between the resonance coils 140 and 210 is further decreased, each peak is divided into two due to the influence of the mutual inductance between the resonance coils 140 and 210. Also, the peak frequency changes depending on the size of the gap between the resonance coils 140 and 210.

In other words, if the gap between the resonance coils 140 and 210 is sufficiently small that the peaks of the S-parameters (S11, S21) are divided into two because of mutual inductance between the resonance coils 140 and 210, the resonant frequency is difficult to adjust because the peak frequency of the S-parameters (S11, S21) varies depending on the variation of the gap between the resonance coils 140 and 210. Thus, in the first embodiment, the resonant frequency of the resonance coils is first adjusted with the mutual inductance between the resonance coils 140 and 210 being low, in other words, the distance between the resonance coils 140 and 210 is sufficiently secured so that each of the S-parameters (S11, S21) has only one peak.

Then, after that, impedance matching is performed using the impedance matching device 152 (FIG. 1) so that the peak value of the transmission characteristic (S21) is increased (i.e., the peak value of the reflection characteristic (S11) decreased).

FIG. 7 is a chart that shows the changes in the transmission characteristic (S21) when the capacitance of the variable capacitors 150 and 220 that are shown in FIG. 1 is varied. Referring to FIG. 7, when the capacitance of the variable capacitors 150 and 220 is varied, the peak value of the transmission characteristic (S21) hardly changes and only the peak frequency changes. It may be, therefore, understood that the resonant frequency may be adjusted with the transmission characteristic (S21) maintained by adjusting the capacitance of the variable capacitors 150 and 220.

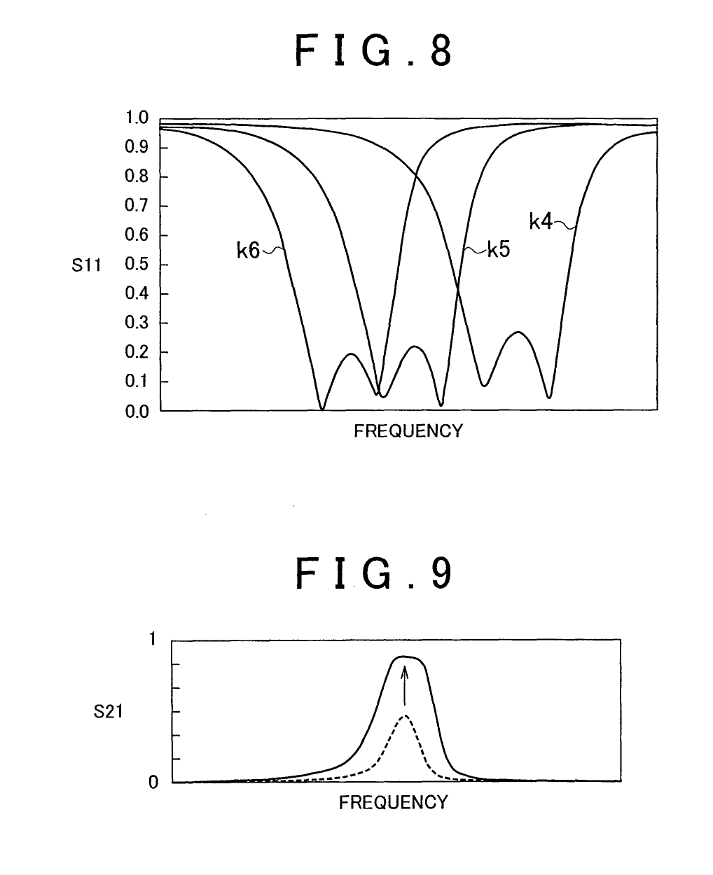

FIG. 8 is a chart that shows the changes in the reflection characteristic (S11) when the capacitance of the variable capacitors 150 and 220, shown in FIG. 1, is varied. Referring to FIG. 8, the peak value of the reflection characteristic (S11) hardly changes and only the peak frequency changes when the capacitance of the variable capacitors 150 and 220 is varied. It can be, therefore, understood that the resonant frequency may be adjusted while the reflection characteristic (S11) remains constant by adjusting the capacitance of the variable capacitors 150 and 220.

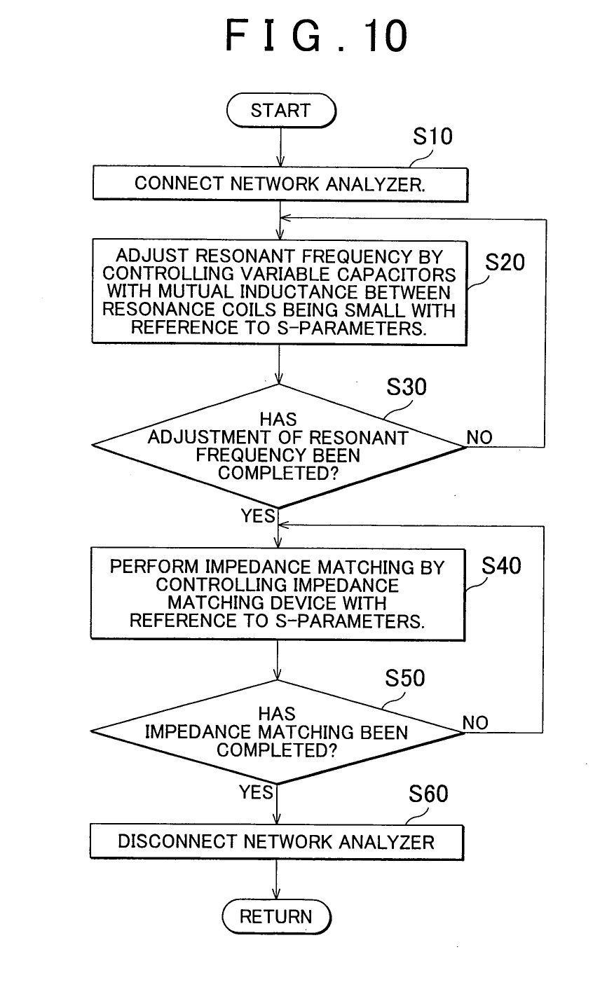

FIG. 9 is a chart that shows the change in the transmission characteristic (S21) when impedance matching is performed using the impedance matching device 152 that is shown in FIG. 1. Referring to FIG. 9, the dotted line indicates the transmission characteristic (S21) before impedance matching, and the solid line indicates the transmission characteristic (S21) after impedance matching. By matching the input impedance of the resonant system with the impedance on the high-frequency power supply device 110 (FIG. 1) side viewed from the input port of the resonant system using the impedance matching device 152, the transmission characteristic (S21) is improved.

FIG. 10 is a flowchart that shows the process executed by an ECU 190 to adjust the resonant frequency of resonance coils and match the impedance of the resonant system. Referring to FIG. 10, the ECU 190 electrically connects the network analyzer 160 to the resonant system by turning on the relay 162 (step S10). The following discussion is based on the assumption that the terminals 320 and 330 in FIG. 1 have been electrically connected to each other.

When the network analyzer 160 is connected, the ECU 190 adjusts the resonant frequency of the resonance coils 140 and 210 to the frequency of the high-frequency electric power that is generated by the high-frequency power supply device 110 by controlling the variable capacitors 150 and 220, with the mutual inductance between the resonance coils 140 and 210 being low (that is, each of the S-parameters (S11, S21) having only a single peak as described before) with reference to the S-parameters (S11, S21) (step S20).

Then, the ECU 190 determines whether the adjustment of the resonant frequency of the resonance coils 140 and 210 by the variable capacitors 150 and 220 has been completed (step S30). For example, it is determined that the adjustment of the resonant frequency has been completed if, for example, the deviation between the resonant frequency of the resonance coils 140 and 210 and the frequency of the high-frequency electric power that is generated by the high-frequency power supply device 110 has become smaller than a predetermined value. If it is determined that the adjustment of the resonant frequency has not been completed yet (NO in step 30), the process returns to step S20.

If it is determined that the adjustment of resonant frequency has been completed in step S30 (YES in step 30), the ECU 190 matches the input impedance of the resonant system with the impedance on the high-frequency power supply device 110 side viewed from the input port of the resonant system by controlling the impedance matching device 152 with reference to the S-parameters (S11, S21) (step S40).

Then, the ECU 190 determines whether the impedance matching by the impedance matching device 152 has been completed (step S50). It is determines that the impedance matching has been completed when, for example, the peak value of the transmission characteristic (S21) has reached an extreme value. If it is determined that the impedance matching has not been completed (NO in step 50), the process returns to step S40.

If it is determined that the impedance matching has been completed in step S50 (YES in step 50), the ECU 190 electrically disconnects the network analyzer 160 from the resonant system by turning off the relay 162 (step S60).

If some positional deviation is expected between the resonance coils 140 and 210 during actual power feeding from the power feeding device 100 to the vehicle 200, the impedance may be adjusted in advance to establish a state where the peaks of the S-parameters start to be divided into two, as shown in FIG. 5, in the adjustment stage, which is performed with no positional deviation between the resonance coils 140 and 210. In this way, the power transmission efficiency may be maximized even if some positional deviation occurs during actual power feeding.

However, if large fluctuations of the gap between the resonance coils 140 and 210 are expected during actual power feeding from the power feeding device 100 to the vehicle 200, the impedance may be adjusted in advance, contrary to the positional deviation case, to establish a state where the peaks of the S-parameters are slightly lower. In this way, deviation of the resonant frequency that is caused by division of the peaks of the S-parameters into two can be prevented even if the gap between the resonance coils 140 and 210 decreases during actual power feeding.

In addition, if the positional deviation between the resonance coils 140 and 210 is small and only minor fluctuations of the gap between the resonance coils 140 and 210 are expected during actual power feeding from the power feeding device 100 to the vehicle 200, the impedance may be adjusted in advance to establish a state where the peaks of the S-parameters may or may not be divided into two.

While the resonance coils 140 and 210 are shown having a circular shape in the above example, the coils are not restricted to having circular shapes. The resonance coils 140 and 210, however, may have a circular shape because the direction of the positional deviation between the resonance coils 140 and 210 during actual power feeding is considered to be random.

As described above, in the first embodiment, based on the measured S-parameters (S11, S21), the resonant frequency of the resonance coils is adjusted by controlling the variable capacitors 150 and 220 and matching the impedance of the resonant system is performed by controlling the impedance matching device 152. As a result, adjustment of the resonant frequency and impedance matching may be performed separately. Therefore, according to this first embodiment, power may be fed very efficiently with simple adjustments.

Also, according to the first embodiment, the resonant frequency and the impedance may be easily adjusted because the resonant frequency is first adjusted when the mutual inductance is low, and impedance matching is performed after the resonant frequency has been adjusted.

As described above, when the gap between the resonance coils 140 and 210 is small, the peaks of the S-parameters (S11, S21) are divided into two as shown in FIG. 6 by the influence of the mutual inductance between the resonance coils 140 and 210 and the resonant frequency deviates. In contrast, when the gap or positional deviation between the resonance coils 140 and 210 is large, the transmission characteristic (S21) is improved as indicated by a dotted line in FIG. 9 when impedance matching is performed.

Therefore, in a second embodiment, the smallest distance between the resonance coils 140 and 210 at which the peaks of the S-parameters (S11, S21) are not divided into two is used as a reference value, and the resonant frequency is adjusted by the variable capacitors 150 and 220 when the distance between the resonance coils 140 and 210 is below the reference value. In contrast, the impedance matching device 152 performs impedance matching when the distance between the resonance coils 140 and 210 exceeds the reference value.

The general configuration of the vehicle power feeding system according to the second embodiment is generally the same as that of the vehicle power feeding system according to the first embodiment shown in FIG. 1.

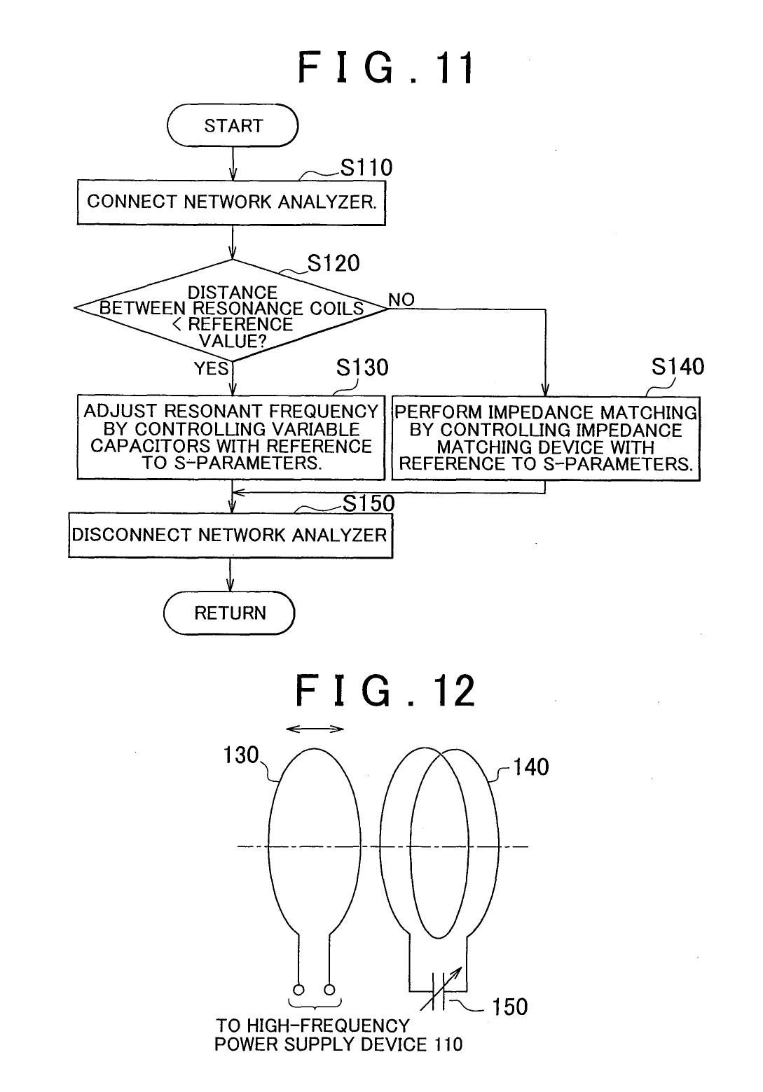

FIG. 11 is a flowchart that explains the procedure executed by the ECU 190 to adjust the resonant frequency of resonance coils and match the impedance of the resonant system in a second embodiment. Referring to FIG. 11, the ECU 190 electrically connects the network analyzer 160 to the resonant system by turning on the relay 162 (step S110). The following discussion is based on the assumption that the terminals 320 and 330 in FIG. 1 have been electrically connected to each other.

Once the network analyzer 160 is connected, the ECU 190 determines whether the distance between the resonance coils 140 and 210 is below the reference value (step S120). The determination may be made based on whether the peaks of the S-parameters (S11, S21) are divided into two or by actually measuring the distance between the coils with a distance sensor.

If it is determined that the distance between the resonance coils 140 and 210 is below the reference value (YES in step 120), the ECU 190 adjusts the resonant frequency of the resonance coils 140 and 210 to match the frequency of the high-frequency electric power that is generated by the high-frequency power supply device 110 by controlling the variable capacitors 150 and 220 with reference to the S-parameters (S11, S21) (step S130).

However, if it is determined that the distance between the resonance coils 140 and 210 is equal to or greater than the reference value (NO in step 120), the ECU 190 matches the input impedance of the resonant system with the impedance on the high-frequency power supply device 110 side viewed from the input port of the resonant system by controlling the impedance matching device 152 with reference to the S-parameters (S11, S21) (step S140).

When the adjustment of the resonant frequency or the impedance matching is completed, the ECU 190 electrically disconnects the network analyzer 160 from the resonant system by turning off the relay 162 (step S150).

As described above, according to this second embodiment, power may be fed very efficiently even if the gap between the resonance coils 140 and 210 or the positional relation between the resonance coils 140 and 210 changes.

While impedance matching is performed by the impedance matching device 152 provided on the input side of the electromagnetic induction coil 130 in each of the above embodiments, the method of impedance matching is not limited to the described manner. The input impedance of the resonant system may be changed by varying the distance between the electromagnetic induction coil 130 and the resonance coil 140. Therefore, as shown in FIG. 12, the electromagnetic induction coil 130 may be moved along the central axis of the electromagnetic induction coil 130 and the resonance coil 140 by an appropriate mechanism or drive unit so that impedance matching may be performed by changing the distance between the electromagnetic induction coil 130 and the resonance coil 140.

In the above, the high-frequency power supply device 110 may be deemed to correspond to an example of “power supply device” in the present invention, and the resonance coil 140 and the electromagnetic induction coil 130 correspond to one example of “power transmission coil” in the present invention. Also, the variable capacitor 150 may be deemed to correspond to one example of “first adjusting device that adjusts the resonant frequency of the power transmission coil” in the present invention, and the impedance matching device 152 may be deemed to correspond to one example of “second adjusting device that adjusts the input impedance of the resonant system” and “third adjusting device” in the present invention.

In addition, the network analyzer 160 may be deemed to correspond to one example of “detection device” in the present invention, and the ECU 190 may be deemed to correspond to one example of “control device” in the present invention. Moreover, the resonance coil 210 and the electromagnetic induction coil 230 may be deemed to correspond to one example of “power receiving coil” in the present invention, and the variable capacitor 220 may be deemed to correspond to one example of “second adjusting device that adjusts the resonant frequency of the power receiving coil” in the present invention.

It is to be understood that the embodiments described herein are illustrative and not limitative in all respects. The scope of the present invention is defined not by the above description of the embodiments but by the claims, and all modifications equivalent to and within the scope of the claims are intended to be included in the scope of the present invention.

1. A power feeding device that feeds electric power in a non-contact manner to a power receiving device that includes a power receiving coil, the power feeding device comprising:
a power supply device that generates electric power of a prescribed frequency;
a power transmission coil that receives the electric power generated by the power supply device and transmits the electric power to the power receiving coil in a non-contact manner by resonating with the power receiving coil via an electromagnetic field;
a first adjusting device that adjusts the resonant frequency of the power transmission coil;
a second adjusting device that adjusts the input impedance of a resonant system that includes the power transmission coil and the power receiving coil;
a detection device that detects at least one of a transmission characteristic and a reflection characteristic of the resonant system; and
a control device that adjusts the resonant frequency to the prescribed frequency by referring to a result of detection by the detection device and controlling the first adjusting device with a single peak appearing in a frequency spectrum of the at least one of the transmission characteristic and the reflection characteristic, and matches the input impedance of the resonant system with the impedance on the power supply device side viewed from the input port of the resonant system by controlling the second adjusting device.

2. The power feeding device according to claim 1, wherein the control device first adjusts the resonant frequency to the prescribed frequency, and, after the resonant frequency has been adjusted to the prescribed frequency, the control device matches the impedance.

3. The power feeding device according to claim 1, wherein the control device determines whether the distance between the power transmission coil and the power receiving coil is below a prescribed reference value, and adjusts the resonant frequency if the distance between the coils is below the reference value and adjusts the input impedance if it is determined that the distance between the coils is equal to or greater than the reference value.

4. The power feeding device according to claim 1, wherein the first adjusting device includes a variable capacitor that is provided in the power transmission coil.

5. The power feeding device according to claim 1,
wherein the second adjusting device includes an LC circuit that is provided between the power transmission coil and the power supply device, and
the LC circuit includes at least one of a variable capacitor and a variable coil.

6. The power feeding device according to claim 1,
wherein the power transmission coil includes a resonance coil, and an electromagnetic induction coil that is connected to the power supply device and supplies the electric power that is received from the power supply device to the resonance coil by electromagnetic induction, and
the second adjusting device adjusts the input impedance by adjusting the distance between the resonance coil and the electromagnetic induction coil.

7. A vehicle power feeding system comprising:
a power feeding device; and
a vehicle that is supplied with electric power from the power feeding device,
wherein the power feeding device includes a power supply device that generates electric power with a prescribed frequency, a power transmission coil that receives the electric power generated by the power supply device and generates an electromagnetic field that is used to transmit the electric power to the vehicle in a non-contact manner, and a first adjusting device that adjusts the resonant frequency of the power transmission coil, and
the vehicle includes a power receiving coil that receives electric power from the power transmission coil in a non-contact manner by resonating with the power transmission coil of the power feeding device via the electromagnetic field, and a second adjusting device that adjusts the resonant frequency of the power receiving coil, and
wherein the power feeding device further includes a third adjusting device that adjusts the input impedance of a resonant system that includes the power transmission coil and the power receiving coil, a detection device that detects at least one of a transmission characteristic and a reflection characteristic of the resonant system, and a control device that adjusts the resonant frequency of the power transmission coil and the power receiving coil to the prescribed frequency by referring to a result of detection by the detection device and controlling the first and second adjusting devices with a single peak appearing in a frequency spectrum of the at least one of the transmission characteristic and the reflection characteristic, and matches the input impedance of the resonant system with the impedance on the power supply device side viewed from the input port of the resonant system by controlling the third adjusting device.

8. The vehicle power feeding system according to claim 7, wherein the control device first adjusts the resonant frequency to the prescribed frequency, and after the resonant frequency has been adjusted to the prescribed frequency, the control device matches the impedance.

9. The vehicle power feeding system according to claim 7, wherein the control device determines whether the distance between the power transmission coil and the power receiving coil is below a prescribed reference value, and adjusts the resonant frequency if it is determined that the distance between the coils is below the reference value and adjusts the input impedance if it is determined that the distance between the coils is equal to or greater than the reference value.
